(19) United States
(12) Patent Application Publication
(10) Pub. No.: US 2007/0056421 A1
(43) Pub. Date: Mar. 15, 2007

(54) Punch blade

(76) Inventor: Fumio Shimizu, Tokyo (JP)

Correspondence Address: Michael S. Leonard;Everest Intellectual Property Law Group, P.O. Box 708, Northbrook, IL, 60065, US

(21) Appl. No.: 11/513,600

(22) Filed: Aug. 31, 2006

(30) Foreign Application Priority Data
Sep. 13, 2005 (JP) 2005-265735

(51) Int. Cl. B26D 5/08; B26D 1/14

(52) U.S. Cl. 83/571; 83/681

(57) ABSTRACT

This invention provides a punch blade formed with a burr inwardly projecting from an outer peripheral edge of a blade tip portion, wherein a film made of a coating liquid is formed inside a tip portion of the punch blade, a portion of the coating liquid forms a coating accumulation at the burr, and the film and the coating accumulation can form the inside of the outer peripheral edge and a periphery of the burr into smooth surfaces, so that a punch residue cut by the punch blade and the lower blade slides on the smooth surface of the film and a surface of the coating accumulation covering the burr, and falls downward, thereby providing the punch blade in which the punch residue does not remain in the blade tip portion with a simple structure.

### BACKGROUND OF THE INVENTION

1. Field of the Invention

The present invention relates to a punch blade of a punch apparatus for punching a hole in a sheet member.

2. Description of the Related Art

In conventional clerical stationery punch apparatuses, a sheet member is inserted into a punching portion, a punch blade is manually or electrically pushed against the sheet member at right angles so that a hole can be punched at a predetermined position of the sheet member. The sheet member is sandwiched and cut between the punch blade and a lower blade having a hole of substantially the same shape as that of the punch blade, and a hole is punched.

As a punch blade, a punch blade whose blade tip portion is wedge-shaped having a V-shaped cross section is used for example. When a hole is punched in a sheet member using such a punch blade, a punched punch residue is prone to be curved along a valley portion of a V-shaped wedge. Elastic resilience which tries to return to its original shape is generated in the curved punch residue. Thus, the punch residue is prone to attach to an inner surface of the V-shaped cross section by the elastic resilience.

If the punch residue attaches to an inside of the punch blade, sharpness of the punch blade is deteriorated, and the number of sheet members which can be punched by the punch blade at a time is reduced. In addition, a punch residue which does not fall on a bottom of a pedestal and is caught in the punch blade is peeled off from the punch blade by insertion of a new sheet member and is moved on an upper surface of a punching surface, and is choked at a sheet member inserting portion which is deeper than a position where a hole is to be punched. A distance from an edge of the sheet member to a hole to be punched is adversely changed due to the punch residue choked at the deep portion of the sheet member inserting portion. In this way, such a phenomenon affects a punching operation to be carried out next adversely, and there is a problem that durability of the punch blade itself is seriously deteriorated.

In a film bonding apparatus of Japanese Patent Laid-open Publication No. 2004-202751, there is proposed a punch blade member constituted such that a punched punch residue does not remain in an inner portion of a punch blade. FIG. 10 shows a perspective view of the punch blade member of Japanese Patent Laid-open Publication No. 2004-202751 as the conventional art in this invention.

As shown in FIG. 10, a blade tip portion 51 of a punch blade member 50 is cut into two V-shaped cross sections such that four side surfaces intersect with each other at right angles, and its four corners are formed with peak portions 52, respectively. A substantially central portion of the blade tip portion 51 of the punch blade member 50 in its axial direction is formed with a pushing pin 55 which is lower than points 53 of the peak portions 52.

With this, the punch blade member 50 can start abutting against the sheet member 60 in a point-contact state from tip ends of the points 53. A hole is gradually punched in the sheet member 60 by inclined surfaces 54 which are cut into V-shaped cross sections. A punched punch residue 61 is pushed into the inward of the punch blade member 50 while curving.

At that time, a back surface side of the punch residue 61 is pressed by the pushing pin 55 so that its deformation is hindered. Thus, as shown in FIG. 11, the punch residue 61 punched by the punch blade member 50 is pushed out by the pushing pin 55, and does not attach to the inside of the punch blade member 50 and easily falls from the punch blade member 50.

According to the punch blade member 50 shown in Japanese Patent Laid-open Publication No. 2004-202751, the punch residue 61 can be discharged from the punch blade member 50 by the pushing pin 55 formed on a central portion of the blade tip. However, complicated manufacturing is required to form two grooves having V-shaped cross sections in the blade tip of the punch blade member 50 and to form the pushing pin 55 on the central portion thereof. Especially, it is difficult processing operation to form a smooth boundary between the grooves having the V-shaped cross sections and the pushing pin 55. Further, it takes a long time to form the two grooves having the V-shaped cross sections and the pushing pin 55 integrally.

In order to enhance the sharpness of the blade tip portion of the punch blade member 50 at the time of cutting operation by the outer peripheral edge thereof and the hole of the lower blade, the outer peripheral edge of the blade tip portion is ground. If the outer peripheral edge of the blade tip portion is ground, the outer peripheral edge can be formed into a sharp form. However, the outer peripheral edge is adversely formed with a burr. In the case of a burr projecting outward from the outer peripheral edge, the burr is removed by contact with the lower blades by the punching operation with respect to the sheet member several times. On the contrary, in the case of a burr projecting inward from the outer peripheral edge, the burr adversely remains on the outer peripheral edge unless a special operation for removing the burr is carried out.

As shown in FIG. 12, if the punching operation to the sheet member is carried out in a state where a burr 62 projecting inward from the outer peripheral edge remains, a peripheral edge of the punch residue 61 engages the burr 62. Thus, even when the pushing pin 55 is formed, the punch residue 61 is not discharged out from the punch blade member 50, and the punch residue 61 attaches to the inside of the punch blade member 50.

### SUMMARY OF THE INVENTION

The object of the present invention is to provide a punch blade in which a pushing pin is not formed on a tip portion of the punch blade, and even if a burr projecting inward from an outer peripheral edge of a blade tip portion remains, a punch residue does not attach to an inside of the tip portion of the punch blade, the punch residue easily falls from the punch blade, and a punching position is not changed.

The object of the present invention can be achieved by each invention according to first and second aspects as follows. That is, in a punch blade of a punch apparatus for punching a hole in a sheet member, according to the first aspect of the present invention, an inner side of an outer peripheral edge of a blade tip portion of the punch blade is coated. This is a most essential feature of the invention.

Consequently, a punch residue punched by the punch blade slips on a coated surface and falls downward from the blade tip portion. With this, the punch residue does not attach to the inner side of the punch blade and it is possible to allow the punch residue to easily fall from the punch blade regardless of its simple configuration.

Further, according to the second aspect of the present invention, in the punch blade including a burr projecting inward of the outer peripheral edge of at least a portion of the outer peripheral edge, a portion of a coating liquid coating the inner side of the outer peripheral edge engages the burr so as to form a coating accumulation. This is an essential feature of the invention.

Even when a burr projects inward of the outer peripheral edge of the punch blade, the inner side of the outer peripheral edge is coated. Consequently, a coating accumulation can be formed at the burr by a portion of the coating liquid applied, sprayed and soaked. The burr can be covered and hidden by the coating accumulation, and it is possible to prevent the punch residue from engaging the burr. In addition, since the surrounding of the burr is covered with the coating accumulation, the punch residue does not engage the burr, slips on the surface of the coating accumulation and falls. Therefore, the punch residue easily falls from the punch blade.

### BRIEF DESCRIPTION OF THE DRAWINGS

FIG. 1 is a vertical sectional view of a portion of a punch apparatus;

FIG. 2 is a schematic enlarged view of a state where a hole is formed in a sheet member;

FIG. 3 is a schematic enlarged view of another state where a hole is formed in a sheet member;

FIG. 4 is an enlarged perspective view of a blade tip portion of the punch blade;

FIG. 5 is a top view of FIG. 2;

FIG. 6 is an enlarged perspective view of a blade tip portion of another punch blade;

FIG. 7 is an enlarged perspective view of a blade tip portion of another punch blade;

FIG. 8 is an enlarged perspective view of a blade tip portion of another punch blade;

FIG. 9 is an enlarged perspective view of a blade tip portion of another punch blade;

FIG. 10 is an enlarged perspective view of a blade tip portion of a punch blade of a conventional punch apparatus;

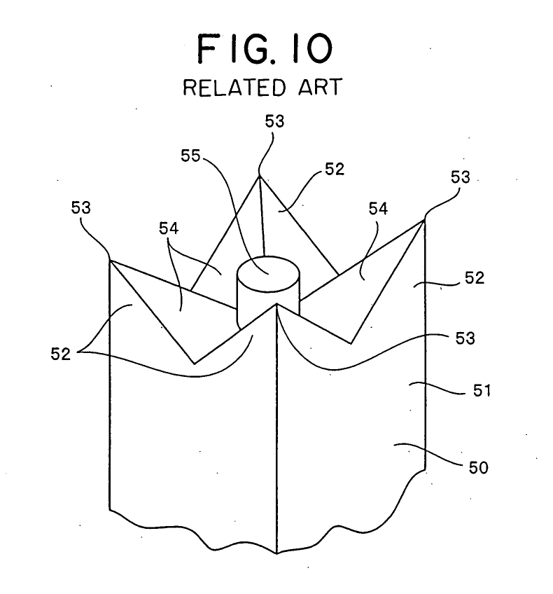

FIG. 11 is a schematic enlarged view of a state where a hole is formed in a sheet member in the above described conventional punch apparatus; and

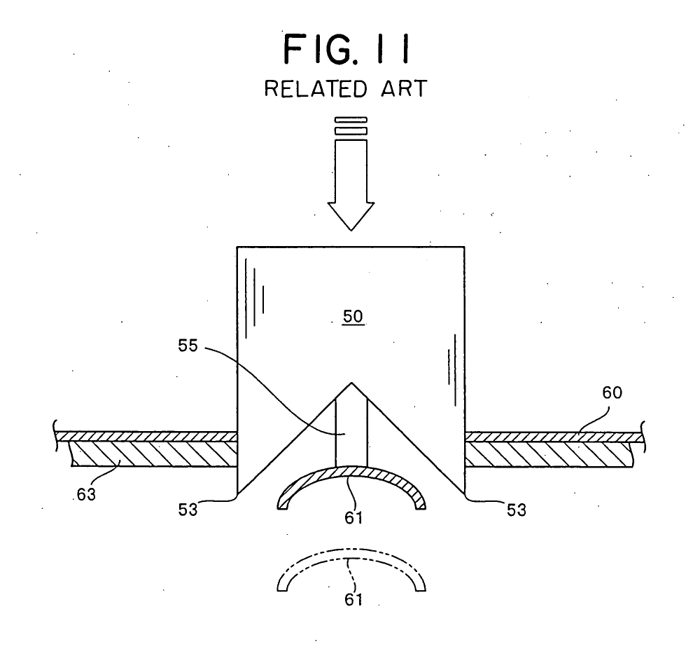

FIG. 12 is a schematic enlarged view of a state where a hole is formed in a sheet member in the above described conventional punch apparatus.

### DESCRIPTION OF THE PREFERRED EMBODIMENT

A preferred embodiment of the present invention will be explained concretely with reference to the accompanying drawings. Shape, layout and structure of the punch blade of the invention other than those explained below can also be employed if the problem defined in this invention can be solved. Thus, the invention is not limited to the embodiment explained below, and the invention can variously be modified.

### First Embodiment

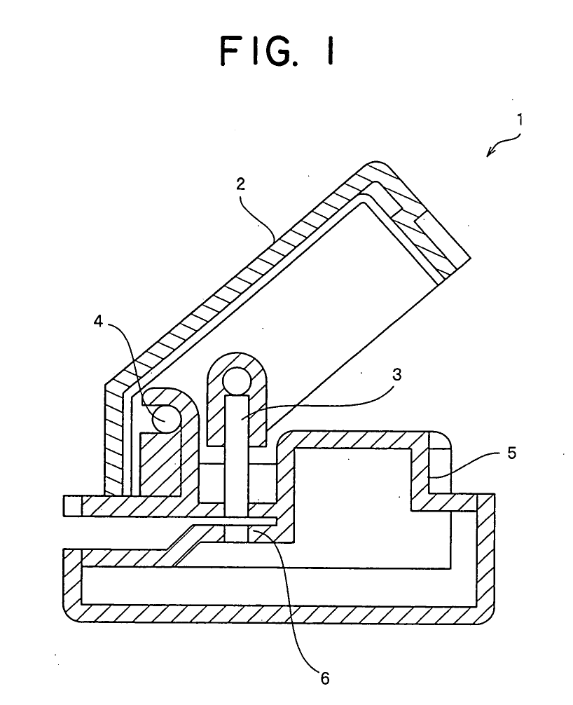

FIG. 1 is a vertical sectional view of a portion of a structure of a typical punch apparatus 1. FIG. 1 is a view used for explaining the punch apparatus 1. The punch apparatus 1 can punch a plurality of holes in a sheet member (not shown). If a handle 2 is vertically turned around a support shaft 4, a punch blade 3 which is provided such that the punch blade 3 can slide with respect to the base portion 5. The sheet member is inserted between the punch blade 3 and a lower blade 6 formed on the base portion 5, it is possible to punch holes in the sheet member by cutting effect of an outer peripheral edge 8 of the punch blade 3 and a hole of the lower blade 6.

A transverse cross section shape of the punch blade 3 may be a rectangular shape, a triangular shape, a circular shape or an oval shape and the like. A shape of the hole at the lower blade 6 through which the punch blade 3 is inserted is a transverse cross section shape which is substantially the same as that of the punch blade 3. A distance between the hole of the lower blade 6 and the punch blade 3 inserted into the hole is about 0.1 mm to about 0.01 mm.

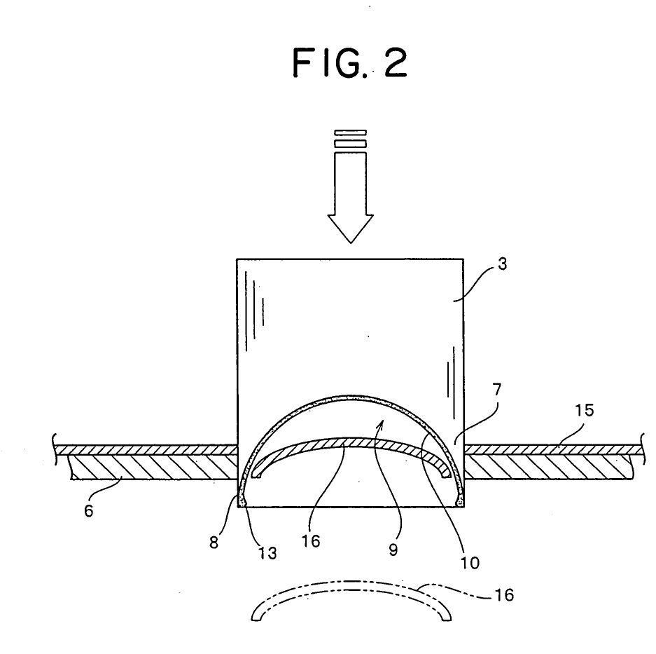

FIG. 2 is a schematic sectional view and shows an enlarged view of an essential portion of a state, in which a hole is formed in a sheet member 15a by using the punch blade 3, the punch blade 3 having a blade tip portion 7 formed with a substantially U-shaped recess as a vertical cross section shape. A film 10, which is formed of a coating liquid such as an adhesive, paint and anticorrosive and the like, is formed at an inside portion of a blade tip portion 7 of the punch blade 3, the inside portion being surrounded by the outer peripheral edge 8. The film 10 can be formed by applying and spraying the coating liquid with respect to the blade tip portion of the punch blade 3 or by soaking the blade tip portion in the coating liquid.

The blade tip portion 7 of the punch blade 3 formed with the film 10 has a smooth surface shape. The outer peripheral edge 8 of the blade tip portion 7 is formed with a bulgy coating accumulation 13 by surface tension of the coating liquid. Therefore, even if the blade tip portion is slightly curved inward of the outer peripheral edge 8, the bulgy coating accumulation 13 absorbs the curving of the blade tip portion and thus, the inner surface of the film 10 becomes smooth.

With this, when holes are punched in the sheet member 15 inserted between the lower blade 6 and the punch blade 3, a punch residue 16 cut by the punch blade 3 and the lower blade 6 slips on the smooth surface due to the film 10 and falls downward. Thus, the punch residue 16 is not discharged to the punch residue accumulation and moves on the upper surface of the punched surface, and it is possible to prevent the clogging at a portion of the sheet member inserting portion which is deeper than the position where holes are punched.

That is, it is possible to avoid a case in which a distance from an edge of the sheet member to the holes is varied due to the punch residue clogged at the deep side of the sheet member inserting portion. In this way, a hole-forming position of the sheet member is not varied by the punch residue 16, and it is possible to always punch a hole by the punch blade 3 at a desired position.

If antistatic material is mixed into the film 10, it is possible to prevent the punch residue 16 from adhering to the film 10 by the antistatic material even when the punch residue 16 is charged with static electricity.

The punch residue 16 does not remain inside of the tip portion of the punch blade 3, and the punch blade 3 can be used always in a state where the punch residue 16 does not attach to the punch blade 3. With this, in the punching operation carried out by the punch blade 3, the thickness of the sheet member 15, in which holes can be punched at a time, can be maintained constant. Further, since the punch residue 16 easily falls from the punch blade 3, the punch residue 16 is always discharged to the punch residue accumulation formed below the lower blade.

Also, since the punch blade 3 can be always used in a state where the punch residue 16 does not attach to the punch blade 3, various adverse influence on the blade tip portion of the punch blade 3 caused by the punch residue 16 can be avoided, and the lifetime of the punch blade 3 can be increased.

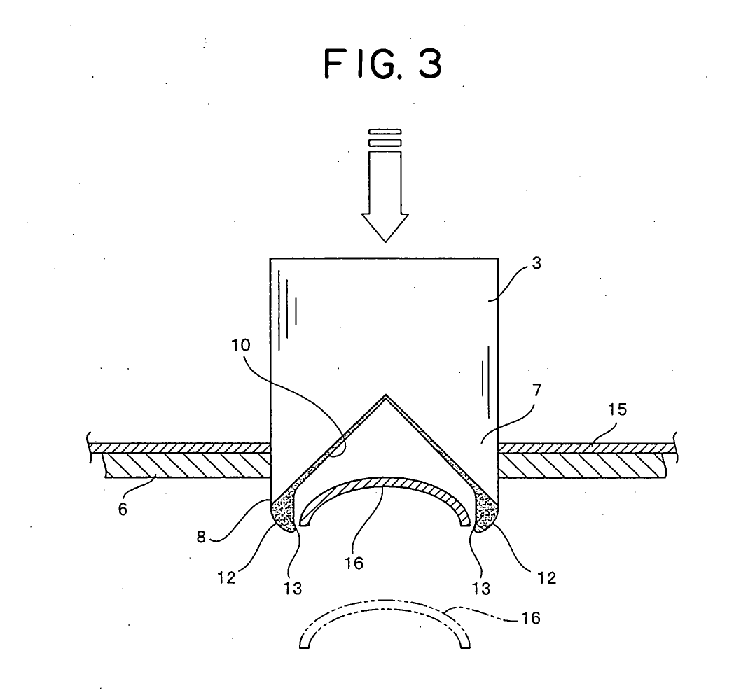

FIG. 3 is a schematic sectional view, and is an enlarged view of an essential portion of a state where a punch blade 3 having a blade tip portion 7 formed with a recess having substantially V-shaped vertical cross section is used, and a hole is formed in a sheet member 15. A burr 12 projecting inward from the outer peripheral edge 8 is formed on the outer peripheral edge 8 of the blade tip portion 7 of the punch blade 3 shown in FIG. 3.

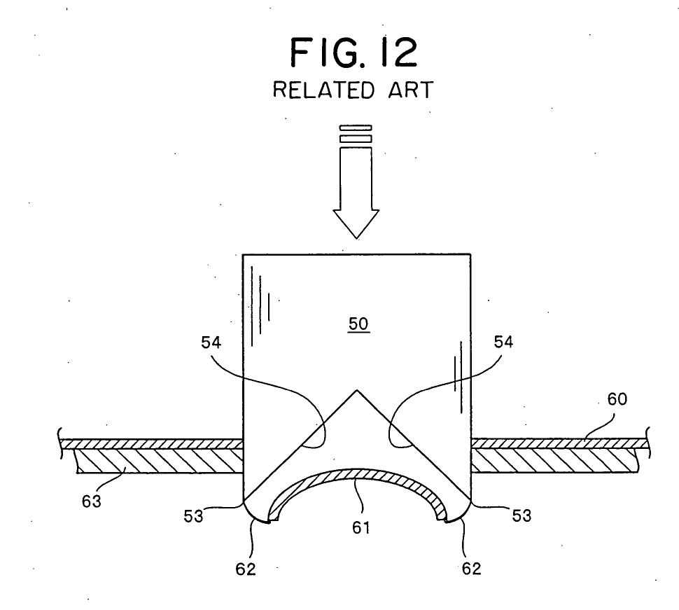

In the above-described explanation of the related art, the case where the burr is formed on the outer peripheral edge has been explained with reference to FIG. 12. In this explanation, if the burr 62 is formed to direct to inward of the outer peripheral edge, the punch residue 61 and the burr 62 engage each other so that the punch residue 61 remains inside of the blade tip portion 51 of the punch blade member 50.

In contrast, in this invention, the film 10 formed by a coating liquid is formed on the inside of the blade tip of the punch blade 3. When the film 10 is formed on the inside of the blade tip of the punch blade 3, the coating accumulation 13 can be formed at the burr 12 by a portion of the coating liquid used for forming the film 10.

FIG. 3 shows the coating accumulation 13 formed at the burr 12. Meanwhile, the thickness of the film 10 and the size and the shape of the coating accumulation 13 are shown exaggerated for purposes of illustration. FIG. 3 shows an example of the coating accumulation 13 formed on an inner surface of the burr 12. However, the burr 12 can be hidden by the thickness of a film depending upon the thickness of the film formed by applying to the blade tip portion 7 of the punch blade 3.

Meanwhile, even when the thickness of the film 10 is increased to hide the burr 12 by the thickness of the film 10, the film portion covering the burr 12 is included in the idea of the coating accumulation of the present invention.

A smooth inner surface of the burr 12 can be formed, or a smooth surface can be formed around the burr 12, by the coating accumulation 13 formed at the burr 12. Thus, when a hole is punched in the sheet member 15 inserted between the lower blade 6 and the punch blade 3, the punch residue 16 cut by the punch blade 3 and the lower blade 6 slips on the smooth surface of the film 10 and the surface of the coating accumulation 13 which covers the burr 12 and falls downward.

With this, even when a punch blade 3 having an inwardly projecting burr 12 is used, the burr 12 and the punch residue 16 are prevented from engaging each other. Thus, the punch residue 16 does not remain inside of the tip portion of the punch blade 3, and the punching operation can be always carried out by the punch blade 3 in a state where the punch residue 16 does not remain. Further, the thickness of the sheet member 15 in which holes can be punched by the punch blade 3 at a time is maintained constant. Since the sharpness of the punch blade 3 is not deteriorated, the lifetime of the punch blade 3 is increased.

Even if the coating accumulation 13 may be peeled off from the outer peripheral edge 8 of the punch blade 3 by repeating the punching operation by the punch blade 3, the burr 12 is also removed from the outer peripheral edge together with the coating accumulation 13. Thus, even when the coating accumulation 13 is eliminated, the punch residue 16 does not remain inside of the punch blade 3 by the burr 12.

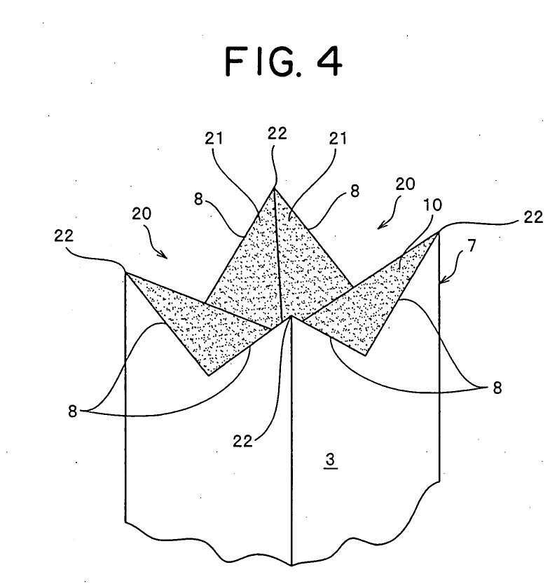

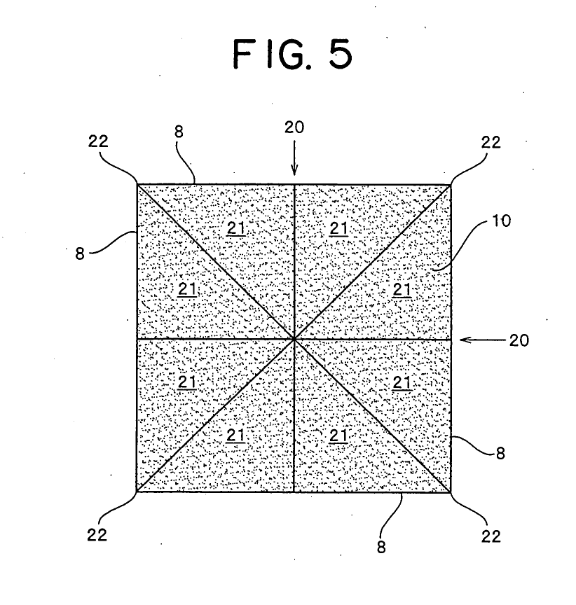

Next, the blade tip portion shape of the blade tip portion 7 of the punch blade 3 will be explained. FIGS. 4 and 6 to 9 are enlarged perspective views of the blade tip portion shape of the punch blade 3 constituted by the present invention. FIG. 5 is a top view of the punch blade 3 shown in FIG. 4.

Meanwhile, the punch blade 3 of the present invention can also be used as a punch blade used for various punch apparatuses other than that shown in FIG. 1 as having a typical structure, such as a punch apparatus for forming plural holes and a punch apparatus incorporated in a copier and the like.

Also, the shape of the blade tip portion of the punch blade 3 shown in FIGS. 4 to 9 show a typical structure as an example, and the shape of the blade tip portion of the punch blade 3 is not limited to that shown in FIGS. 4 to 9.

In the punch blade 3 shown in FIG. 4, a square pole shape blade tip portion 7 is formed with two cuts 20 having V-shaped cross sections, and the two cuts 20 intersect with each other at right angles. The four corners of the square pole blade tip portion 7 are formed with acuminated portions 22. As shown in FIG. 5, downwardly inclined surfaces 21 are formed on both sides of the edge lines in which the acuminated portions 22 are vertices. Also, the blade tip portion 7 of the punch blade 3 surrounded by the outer peripheral edge 8 is coated with the film 10 shown with the pearskin finish-like points.

With this, the punch blade 3 can first make contact with the sheet member (not shown) by the acuminated portions 22 at the four corners in a point-contact manner. In addition to the cutting operation by the lower blade (not shown) and the outer peripheral edge 8, a hole can be punched in the sheet member gradually by the inclined surfaces 21 which constitute the cuts 20 having the V-shaped cross sections. Therefore, when the sheet member is to be cut, it is possible to cut the sheet member without applying excessive force to the blade tip portion 7 of the punch blade 3.

Further, even when a burr is formed on the outer peripheral edge 8 or an edge line by the cut 20 having the V-shaped cross section, the burr can be coated with the film 10 or the coating accumulation (not shown). Thus, it is possible to prevent punch residue from remaining inside of the blade tip portion 7 of the punch blade 3.

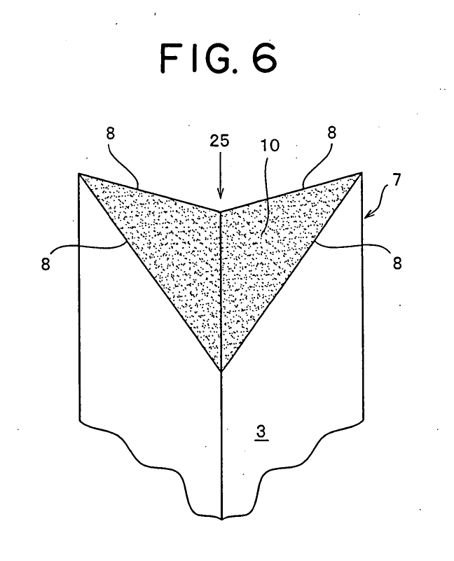

According to a punch blade 3 shown in FIG. 6, a triangle pole tip portion is formed with a blade. A traverse cross section shape of the blade is formed by a cut 25 having a V-shaped cross section passing through one of vertices of the triangle. A hole can be punched in the sheet member by the outer peripheral edge 8 of the triangle pole tip portion and a hole having a triangle cross section formed in the lower blade (not shown).

The blade tip portion 7 of the punch blade 3 surrounded by the outer peripheral edge 8 is coated with the film 10 shown with the pearskin finish-like points. Even when a burr is formed on the outer peripheral edge 8, the burr can be coated with the film 10 or the coating accumulation (not shown). Thus, it is possible to prevent a punch residue from remaining inside the blade tip portion 7 of the punch blade 3.

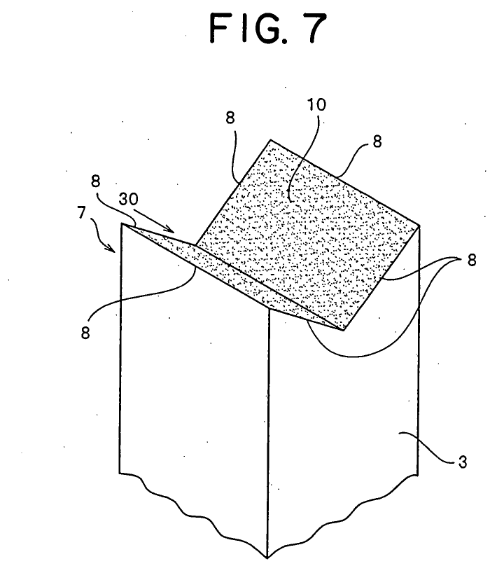

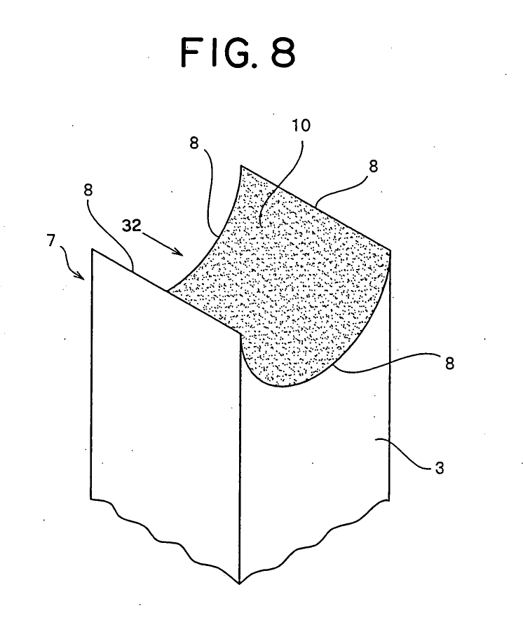

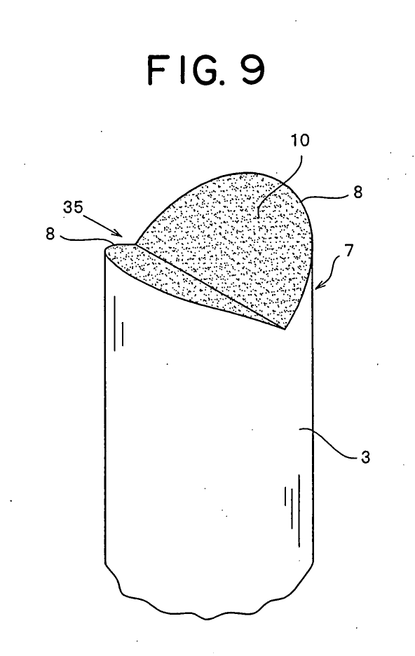

FIG. 7 shows a blade tip portion shape of a punch blade 3 in which a square pole blade tip portion 7 is formed with a cut 30 having V-shaped cross section. FIG. 8 shows a blade tip portion shape of a punch blade 3 in which a square pole blade tip portion 7 is formed with a cut 32 having U-shaped cross section. FIG. 9 shows a blade tip portion shape of a punch blade 3 in which a cylindrical blade tip portion 7 is formed with a cut 35 having V-shaped cross section.

An inner side of an outer peripheral edge 8 of a blade tip portion 7 of a punch blade 3 shown in FIGS. 7 to 9 is coated with a film 10 shown with pearskin finish-like points. Even when a burr is formed on the outer peripheral edge 8, the burr can be coated with the film 10 or the coating accumulation (not shown). Thus, it is possible to prevent a punch residue from remaining inside the blade tip portion 7 of the punch blade 3.

Instead of forming the cut 35 having the V-shaped cross section on the cylindrical tip portion shown in FIG. 9, it is possible to form a punch blade formed with a cut having U-shaped cross section. Instead of forming the punch blade into the square pole shape, the punch blade may have a transverse cross section shape corresponding to a shape of a hole to be punched in the sheet such as a transverse cross section shape of polygonal shape and an oval shape and the like. As a shape of a cross section of the cut, it is possible to employ an appropriate shape such as a U-shape, a V-shaped and a combination thereof.

In these punch blades also, the inner side of the outer peripheral edge of the blade tip portion of the punch blade can be coated with the film. Even if a burr is formed on the outer peripheral edge or the like, the coating accumulation can be formed at the burr by a coating liquid at the time of forming the blade tip portion.

According to the present invention, the technical idea thereof can be applied to blades to which the technical idea of the invention can be applied.

What is claimed is:

1. A punch blade of a punch apparatus for punching a hole in a sheet member, wherein an inner side of an outer peripheral edge of a blade tip portion of the punch blade is coated.

2. The punch blade according to claim 1, including a burr projecting inward of the outer peripheral edge of at least a portion of the outer peripheral edge, wherein a portion of a coating liquid coating the inner side of the outer peripheral edge engages the burr so as to form a coating accumulation.
